(19) United States
(12) Patent Application Publication
(10) Pub. No.: US 2026/0251134 A1
(43) Pub. Date: Aug. 27, 2026

(54) DOUBLE DIAPHRAGM PUMP WITH IMPROVED PLAIN BEARING

(71) Applicant: Lutz Pumpen GmbH, Wertheim (DE)

(72) Inventor: Felix SCHNEIDER, Külsheim (DE)

(73) Assignee: Lutz Pumpen GmbH, Wertheim (DE)

(21) Appl. No.: 19/546,743

(22) Filed: Feb. 23, 2026

(30) Foreign Application Priority Data
Feb. 24, 2025 (EP) 25159677.1

(51) Int. Cl. F04B 43/02; F04B 43/04; F04B 43/06

(52) U.S. Cl. CPC F04B 43/02; F04B 43/04; F04B 43/06

(57) ABSTRACT

A double diaphragm pump has two diaphragm chambers separated by a center block, in which adjacent media chambers are delimited in each case using a diaphragm. The diaphragms are interconnected through a through-opening of the center block by a diaphragm rod. The through-opening has a plain bearing which contacts the diaphragm rod and is manufactured from the material of the center block. The diaphragm rod has a circumferential surface to which a continuous sliding coating is assigned. The diaphragm rod has end-side tapered portions for passage through the diaphragms, and the sliding coating is applied only between the tapered portions. The center block is manufactured without joints and the diaphragm rod receives a sliding coating that covers the entire circumferential surface contacting the medium. As a result, germs find no locations to adhere to and the double diaphragm pump is significantly easier to clean and more hygienic to operate.

### CROSS REFERENCE TO RELATED APPLICATIONS

Applicant claims priority under 35 U.S.C. §119 of European Application No. 25159677.1 filed Feb. 24, 2025, the disclosure of which is incorporated by reference.

### BACKGROUND OF THE INVENTION

### 1. Field of the Invention

The present invention relates to a double diaphragm pump with two diaphragm chambers separated by a center block, in which media chambers adjacent to the center block are delimited with the aid of a diaphragm in each case, wherein the diaphragms are interconnected through a through-opening of the center block by means of a diaphragm rod, wherein the through-opening has a plain bearing that contacts the diaphragm rod and is manufactured from the material of the center block, and the diaphragm rod has a circumferential surface to which a continuous sliding coating is assigned.

### 1. Description of the Related Art

Such a double diaphragm pump is already known from US 8 469 681 B2. Reference is further made to DE 10 2006 028 860 A1, which proposes different regions of the plain bearing coating with different bearing material particles.

Double diaphragm pumps that operate according to the central-flow principle are characterized in that they have high flow efficiency. A substantial challenge in this design is the connection of the two diaphragms, which is generally effected by a diaphragm rod that moves linearly in the medium. Since the diaphragm rod is guided through the center block, a plain bearing arrangement between the center block and the diaphragm rod is required.

For hygienic applications, pumps are often made of stainless steel, as this material is convincing due to its durability and strength and can be cleaned effectively. However, the guidance of the diaphragm rod often represents a problem in the hygienic field. In known embodiments of double diaphragm pumps operated according to the central-flow principle, a plastic plain bearing is pressed into the center block, through which the diaphragm rod, which is usually manufactured from stainless steel, is guided. A diaphragm rod made of suitable plastic cannot always be used; in particular it cannot be used when high axial forces are acting thereon. When using a pressed-in plain bearing, the question arises as to whether the connection point between the center block and the plain bearing is and remains hygienic, since germs can settle and multiply in the edge regions of the components.

### SUMMARY OF THE INVENTION

Against this background, the present invention is based on the object of creating a double diaphragm pump in which, on the one hand, a permanently loadable plain bearing arrangement is realized, but a hygienic solution is created in which the formation of germs in the edge regions of assembled components can be avoided.

This is achieved by a double diaphragm pump with the features of the invention. Practical embodiments of such a double diaphragm pump are discussed below.

In this respect, a double diaphragm pump with two diaphragm chambers separated by a center block is provided, in which media chambers adjacent to the center block are delimited in each case with the aid of a diaphragm, wherein the diaphragms are interconnected through a through-opening of the center block by means of a diaphragm rod. According to the invention, such a double diaphragm pump is characterized in that the through-opening has a plain bearing that contacts the diaphragm rod and is manufactured from the material of the center block, and the diaphragm rod has a circumferential surface to which a continuous sliding coating is assigned.

Here, as in the known pumps, a plain bearing is formed from a sliding coating that slides over a material surface, but the pressing of a plain bearing into the center block is omitted. Instead of pressing the plain bearing into the intermediate wall of the center block, the wall of the center block is instead manufactured continuously from one material up to the through-opening. As a result, there is no location for possible germs at which they can settle and multiply, since no grooves between the abutting components are required. Conversely, a counter-surface capable of sliding relative to the through-opening can likewise be created by coating the entire diaphragm rod or a circumferential surface of the diaphragm rod. As a result, since the entire diaphragm rod or its circumferential surface, that is the cylindrical circumferential surface that slides through the through-opening, is coated without gaps and over its surface, no formation of germs can occur there either. This results in a hygienic and easy-to-clean double diaphragm pump.

In a preferred embodiment, it can in particular be provided that the center block forms, on both sides, a media chamber wall adjoining the particular diaphragm in one piece and without joints. To the extent that the media chamber is assembled from a plurality of components, the formation of germs can occur in each butt joint, so that such butt joints are to be avoided in principle. The butt joint between the diaphragm and the center block cannot be avoided due to the mobility of the diaphragm material, but it can be cleaned easily by disassembling the diaphragm. The center block is thus only a single solid component, which is very easy to clean and robust and durable. Even in the event of damage to the sliding coating of the diaphragm rod, the diaphragm rod would be comparatively easy to replace, so that the service life of the described solution is significantly increased compared to the prior art.

It can further be provided that edges occurring on the center block are rounded. These are in particular the media inlets and outlets. To the extent that the edges are sharp, inaccessible locations can remain there during cleaning. Due to a uniform rounding, accessibility for cleaning can be further increased and hygiene in this area can also be improved.

In particular, it can be provided that the center block is manufactured from stainless steel or a stainless steel alloy. This material is particularly durable, easy to clean and does not corrode in air. It also does not react with the media conveyed in the double diaphragm pump, so that these can be conveyed unaffected by the diaphragm pump as such.

In a specific embodiment, it can further be provided that the diaphragm rod has end-side tapered portions for passage through the diaphragms, wherein the sliding coating is applied only between the tapered portions. When the tapered regions are guided through the passages of the diaphragms, the end faces between the circumferential region and the tapered region already bear against the diaphragms. A seal is usually provided here, so that the sliding coating can also be omitted here, since the said edge exists in any case. Omission of the sliding coating at this location means no transition and no seam at which additional germs could arise.

In addition, it can be provided that the diaphragm rod has end-side connection means for connection to a drive. In principle, a double diaphragm pump according to the central-flow principle can also be operated purely pneumatically. In such a case, the diaphragm rod can remain free on both sides, and a drive medium is alternately introduced behind the diaphragms, that is in the pressure chambers opposite the respective media chambers, which actuates the particular diaphragm. The other diaphragm is actuated via the diaphragm rod and simultaneously displaces the drive medium from the other pressure chamber. After such a stroke, the same process is effected in the opposite direction. If, however, an electric drive is used, a drive plunger can be connected to the diaphragm rod and the drive medium can be omitted. A parallel use of the mechanical and the pneumatic drive type can also be used.

As an alternative to an end-side fastening, it can be provided in otherwise the same manner that the diaphragm rod is designed as a hollow tube, through which connection means for connection to a drive are passed. In particular, a connection element for connection to the drive can then be provided, which is connected to the diaphragm rod with the aid of a continuous screw that can be guided in a sleeve.

Preferably, the drive can be an electric or pneumatic drive and can be mountable as a whole with a housing part to the double diaphragm pump. This allows the drive used on a double diaphragm pump to be exchanged as required or drives to be used on both sides, if the application requires this.

Similar to the center block, the diaphragm rod can also be manufactured from stainless steel or a stainless steel alloy. Such a material can absorb significantly greater forces than a diaphragm rod made of plastic, so that the behavior of the diaphragm rod does not differ from that of known diaphragm rods made of stainless steel.

With particular advantage, it can be provided that the sliding coating is a plastic coating, preferably a coating made of polytetrafluoroethylene. Such a coating is particularly capable of sliding, is durable and does not react with the conveyed media.

### BRIEF DESCRIPTION OF THE DRAWINGS

The above-described invention is explained in more detail below with reference to an exemplary embodiment.

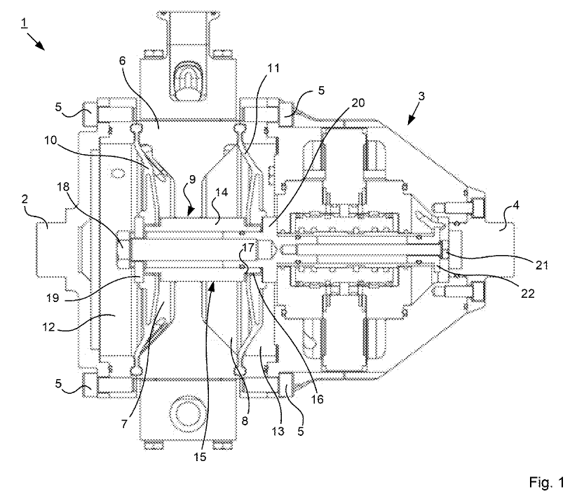

For this purpose, FIG. 1 shows a double diaphragm pump according to the central-flow principle with a diaphragm rod with a sliding coating in a lateral cross-sectional representation.

### DETAILED DESCRIPTION OF PREFERRED EMBODIMENTS

Such a double diaphragm pump 1 is substantially constructed from a center block 6, which is closed on one side by a cover 2 and on the other side by a drive 3. Housing parts can additionally be interposed, in which the required air routing is preferably also accommodated, in order to alternately supply compressed air to the first pressure chamber 12 behind the first diaphragm 10 and to the second pressure chamber 13 behind the second diaphragm 11. For this purpose, the drive 3 serves as both a mechanical and a pneumatic drive. With the aid of connecting screws 5, the drive 3 on the one hand and the cover 2 on the other hand are connected to the housing parts of the double diaphragm pump 1, in the center of which the center block 6 is accommodated. The diaphragms 10 and 11 divide the diaphragm chambers into a first media chamber 7 and a first pressure chamber 12 and a second media chamber 8 and a second pressure chamber 13.

The two diaphragms are interconnected via a diaphragm rod 14, so that they move in synchronism. Here, the diaphragm rod 14 passes through a through-opening 9 of the center block 6, which is manufactured entirely from stainless steel. The diaphragm rod 14 is likewise manufactured from stainless steel but is coated between its tapered portions 16 with a sliding coating 15 made of polytetrafluoroethylene, so that the circumferential surface of the diaphragm rod 14 seals against the through-opening 9 of the center block but is guided therein in a sliding manner. As a result, since the media chambers 7 and 8 consist only of the diaphragms 10 and 11 themselves and the walls of the center block 6 manufactured continuously from stainless steel, and in particular pressed-in plain bearings in the through-opening 9 are omitted, no germs can form in the media chambers 7 and 8 and the double diaphragm pump 1 is particularly easy to clean. An interface exists only between the center block 6 and the diaphragms 10 and 11 and between the diaphragms 10 and 11 and the diaphragm rod 14. However, the end face of the tapered portions 16 is also provided with a seal 17 between the diaphragms 10 and 11 and the diaphragm rod 14, so that the additional penetration of germs cannot be detected there either.

In the present embodiment, the diaphragm rod 14 is designed as a hollow tube and is connected to the drive 3 with a connection element 20, which is fastened on the side of the diaphragm rod 14 via a first screw 18 and a first sleeve 19 and from the side of the drive via a second screw 21 and a second sleeve 22. The second screw 21 and the second sleeve 22 are accessible via a drive cover 4 in the housing of the drive 3.

Thus, described above is a double diaphragm pump in which, on the one hand, a permanently loadable plain bearing arrangement is realized, but a hygienic solution is created in which the formation of germs in the edge regions of assembled components can be avoided.

Although only a few embodiments of the present invention have been shown and described, it is to be understood that many changes and modifications may be made thereunto without departing from the spirit and scope of the invention.

### LIST OF REFERENCE SIGNS

1 double diaphragm pump

2 cover

3 drive

4 drive cover

5 connecting screws

6 center block

7 first media chamber

8 second media chamber

9 through-opening

10 first diaphragm

11 second diaphragm

12 first pressure chamber

13 second pressure chamber

14 diaphragm rod

15 sliding coating

16 tapered portion

17 seal

18 first screw

19 first sleeve

20 connection element

21 second screw

22 second sleeve

What is claimed is:

1. A double diaphragm pump with two diaphragm chambers (7, 8) separated by a center block (6), in which media chambers (7, 8) adjacent to the center block (6) are delimited in each case with the aid of a diaphragm, wherein the diaphragms (10, 11) are interconnected through a through-opening (9) of the center block (6) by means of a diaphragm rod (14),
wherein the through-opening (9) has a plain bearing which contacts the diaphragm rod (14) and is manufactured from the material of the center block (6), and the diaphragm rod (14) has a circumferential surface to which a continuous sliding coating (15) is assigned,
wherein the diaphragm rod (14) has end-side tapered portions (16) for passage through the diaphragms (10, 11), wherein the sliding coating (15) is applied only between the tapered portions (16).

2. The double diaphragm pump according to claim 1, wherein the center block (6) forms, on both sides, a media chamber wall adjoining the respective diaphragm (10, 11) in one piece and without joints.

3. The double diaphragm pump according to claim 1, wherein edges occurring on the center block (6) are rounded.

4. The double diaphragm pump according to claim 1, wherein the center block (6) is manufactured from stainless steel or a stainless steel alloy.

5. The double diaphragm pump according to claim 1, wherein the diaphragm rod (14) has end-side connection means for connection to a drive (3).

6. The double diaphragm pump according to claim 1, wherein the diaphragm rod (14) is configured as a hollow tube through which connection means (18, 19, 20, 21, 22) for connection to a drive (3) are passed.

7. The double diaphragm pump according to claim 5, wherein the drive (3) is an electric or pneumatic drive and is mountable as a whole with a housing part to the double diaphragm pump (1).

8. The double diaphragm pump according to claim 1, wherein the diaphragm rod (14) is manufactured from stainless steel or a stainless steel alloy.

9. The double diaphragm pump according to claim 1, wherein the sliding coating (15) is a plastic coating.

10. The double diaphragm pump according to claim 1, wherein the sliding coating (15) is a coating made of polytetrafluoroethylene.
